(19) United States
(12) Patent Application Publication
(10) Pub. No.: US 2025/0048307 A1
(43) Pub. Date: Feb. 6, 2025

(54) METHOD AND SYSTEM FOR HANDLING MOBILE BASE STATION RELAY AND DISCONTINUOUS COVERAGE

(71) Applicant: SAMSUNG ELECTRONICS CO., LTD., Suwon-si (KR)

(72) Inventors: Lalith KUMAR, Bangalore (IN); Aman AGARWAL, Bangalore (IN); Sidhant JAIN, Bangalore (IN); Mahmoud WATFA, Middlesex (GB)

(21) Appl. No.: 18/791,965

(22) Filed: Aug. 1, 2024

(30) Foreign Application Priority Data
Aug. 1, 2023 (IN) 202341051783
Aug. 2, 2023 (IN) 202341052066
Jul. 19, 2024 (IN) 202341051783

(51) Int. Cl. H04W 60/06; H04W 36/08; H04W 88/04

(52) U.S. Cl. CPC H04W 60/06; H04W 36/08; H04W 88/04

(57) ABSTRACT

The disclosure relates to a 5G or 6G communication system for supporting a higher data transmission rate. The embodiments herein provide a method of a network entity for handling a mobile base station relay (MBSR), the method comprising: identifying that an MBSR authorization state changes to not authorized; transmitting, to a base station, a first message including an authorization indication indicating that the MBSR authorization state is not authorized; receiving, from the base station, a second message including a first indication indicating that an operation for a non-authorized MBSR has completed; and performing a de-registration procedure with the MBSR in response to receiving the first indication.

### CROSS REFERENCE TO RELATED APPLICATIONS

This application is based on and claims priority under 35 U.S.C. § 119 to Indian Provisional Applications Nos. 202341051783 and 202341052066, filed on Aug. 1, 2023, and Aug. 2, 2023, and Indian Complete application No. 202341051783, filed on Jul. 19, 2024, in the Indian Intellectual Property Office, the disclosure of which are incorporated by reference herein in their entirety.

### BACKGROUND

### 1. Field

Embodiments disclosed herein relate to wireless communication networks, and more particularly to methods and systems for handling a mobile base station relay (MBSR) user equipment (UE) registration, emergency calls, and handling a start of unavailability period and unavailability period duration for discontinuous coverage scenarios in wireless communication networks.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Accordingly, the embodiments herein provide a method of a network entity for handling a mobile base station relay (MBSR), the method comprising: identifying that an MBSR authorization state changes to not authorized; transmitting, to a base station, a first message including an authorization indication indicating that the MBSR authorization state is not authorized; receiving, from the base station, a second message including a first indication indicating that an operation for a non-authorized MBSR has completed; and performing a de-registration procedure with the MBSR in response to receiving the first indication.

Accordingly, the embodiments herein provide a network entity for handling a mobile base station relay (MBSR), the network entity comprising: a transceiver; and at least one processor coupled to the transceiver and configured to: identify that an MBSR authorization state changes to not authorized, transmit, to a base station, a first message including an authorization indication indicating that the MBSR authorization state is not authorized, receive, from the base station, a second message including a first indication indicating that an operation for a non-authorized MBSR has completed, and perform de-registration procedure with the MBSR in response to receiving the first indication.

Accordingly, the embodiments herein provide a method of a base station for handling a mobile base station relay (MBSR), the method comprising: receiving, from a network entity, a first message including an authorization indication that an MBSR authorization state changes to not authorized; performing an operation for a non-authorized MBSR based on the authorization indication; and transmitting, to the network entity, a second message including a first indication indicating that the operation for the non-authorized MBSR has completed.

Accordingly, the embodiments herein provide a base station for handling a mobile base station relay (MBSR), the base station comprising: a transceiver; and at least one processor coupled to the transceiver and configured to: receive, from a network entity, a first message including an authorization indication that an MBSR authorization state changes to not authorized, perform an operation for a non-authorized MBSR based on the authorization indication, and transmit, to the network entity, a second message including a first indication indicating that the operation for the non-authorized MBSR has completed.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 illustrates a scenario where an MBSR UE registers for emergency services according to existing arts;

FIG. 2 illustrates a scenario where the UE is de-registering an IAB MBSR UE according to existing arts;

FIG. 3 illustrates a scenario for handling emergency services and NR/E-UTRAN satellite access network according to existing arts;

FIG. 4 illustrates a system for handling an MBSR UE according to embodiments as disclosed herein;

FIG. 5 illustrates a method for handling the MBSR UE by a network according to embodiments as disclosed herein;

FIG. 6 illustrates a method for handling the MBSR UE by a base station according to embodiments as disclosed herein;

FIG. 7 illustrates a scenario where an MBSR UE is not allowed to act as the MBSR UE when the MBSR UE is registered for an emergency service according to embodiments as disclosed herein;

FIG. 8 illustrates another scenario where an MBSR UE is not allowed to act as the MBSR UE when registered for an emergency service according to embodiments as disclosed herein;

FIG. 9 illustrates another scenario where an MBSR UE is not allowed to act as the MBSR UE when registered to a network for example due to emergency service according to embodiments as disclosed herein;

FIG. 10 illustrates a scenario depicting one or more actions performed by the network before de-registering an MBSR UE and the actions performed by UEs connected via the MBSR UE to prevent service loss according to embodiments as disclosed herein; and

FIG. 11A and FIG. 11B illustrate a method for handling emergency services for a UE according to embodiments as disclosed herein.

### DETAILED DESCRIPTION

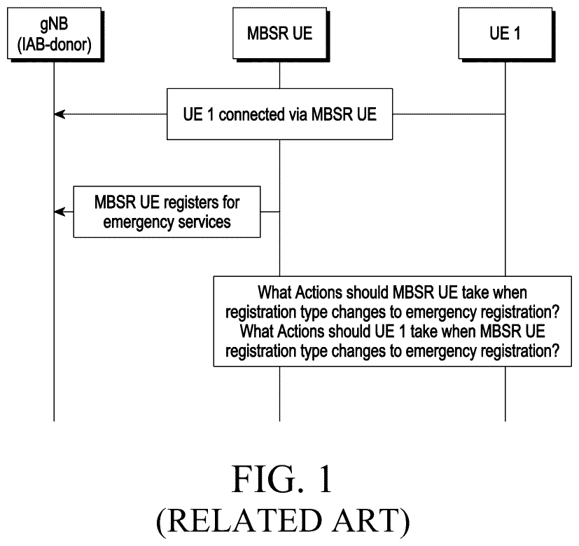

FIG. 1 through FIG. 11B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising,” “having” and “including” are to be construed as open-ended terms unless otherwise noted.

The words/phrases “exemplary,” “example,” “illustration,” “in an instance,” “and the like,” “and so on,” “etc.,” “etcetera,” “e.g.,” “i.e.,” are merely used herein to mean “serving as an example, instance, or illustration.” Any embodiment or implementation of the present subject matter described herein using the words/phrases “exemplary,” “example,” “illustration,” “in an instance,” “and the like,” “and so on,” “etc.,” “etcetera,” “e.g.,” “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

MBSR is a mobile base station relay that acts as a relay between a user equipment (UE) and a 5th generation (5G) network, i.e., providing a new radio (NR) access link to UEs, and connecting wirelessly (using NR) through an integrated access and backhaul (IAB)-donor to a 5G core. MBSR can be used in scenarios where there are coverage gaps or areas with weak signals, such as rural areas, underground tunnels, or large buildings. They help improve the overall performance and coverage of the mobile network, ensuring a more reliable and seamless communication experience for mobile users. MBSR uses a feature integrated access and backhaul (IAB).

The MBSR uses the IAB architecture and operates as an IAB node (with an IAB-UE and gNB-DU) with mobility when integrated with a serving public land mobile network (PLMN). Additionally, the following limitations apply to the MBSR:
the MBSR has a single hop to the IAB-donor node; and/or
NR Uu is used for a radio link between an MBSR and served UEs, and between MBSR and IAB-donor node.

For an MBSR node to operate as an MBSR, the MBSR node provides a mobile IAB-indication to the IAB-donor-central unit (CU) when a radio resource control (RRC) connection is established. When the mobile IAB-indication is received, the IAB-donor-CU selects an access and mobility management function (AMF) that supports IAB-node with mobility and includes the mobile IAB-indication in the N2 INITIAL UE MESSAGE, so that the AMF can perform mobile IAB authorization. If the MBSR node does not operate as an MBSR, for example, due to the MBSR authorization indication from the AMF, the MBSR node does not provide the indication when establishing new RRC connection.

FIG. 1 illustrates a scenario where an MBSR UE registers for emergency services. A UE is authorized to act as an MBSR UE. An MBSR UE is connected to 5G core, providing a NR access link to UEs, and connected wirelessly (using NR) through an IAB-donor to the 5G Core. If the MBSR UE is registered for emergency services, may the UE continue to act as MBSR UE is not clearly specified in current methods. If the MBSR UE is not allowed to act as MBSR UE when registered for emergency service, what may be the behavior of connected UEs and MBSR UE is not defined.

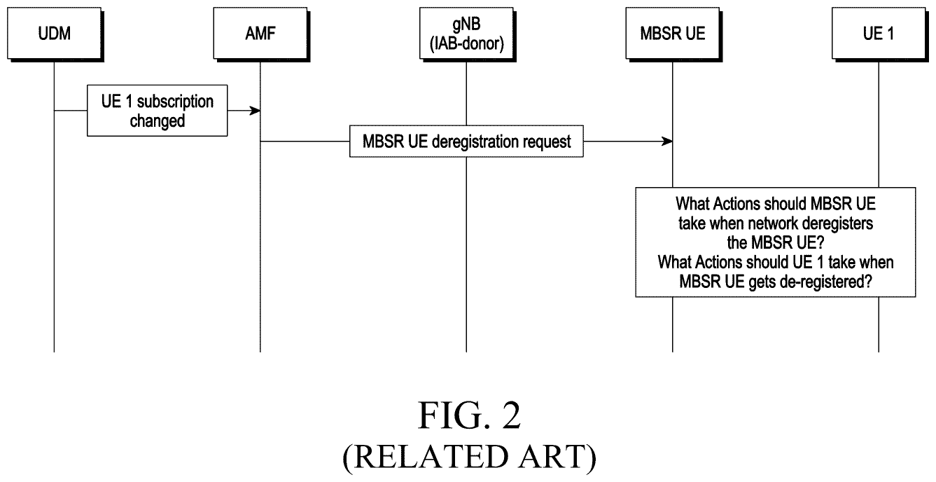

FIG. 2 illustrates a scenario where the UE is de-registering an IAB MBSR UE. For example, the unified data management (UDM) can trigger a Nudm_UECM_DeregistrationNotification procedure for operator-determined purposes to request the removal of a subscriber's RM context and PDU Session(s) of the UE when the UE's subscription state changes. The AMF, when the AMF receives such a request from the UDM or on expiry of an implicit de-registration timer for the UE, or any other trigger for a Network Initiated de-registration Procedure. At this point what may be the behavior of the MBSR UE/network/AMF is not defined for graceful release of the MBSR UE. MBSR if the MBSR suddenly stops operating (because of deregistraiton procedure triggerred by network) then serving UEs of the MBSR (which is acting like a gNB) may stop the service abruptly and the MBSR may have an impact to ongoing services of those UEs. Thus, a solution is desired to perform a graceful release of those UEs.

For a 5G system with satellite access, the following requirement applies: the 5G system may support service continuity between NR terrestrial access network and NR satellite access networks owned by the same operator or owned by 2 different operators having an agreement.

The non-terrestrial networks (NTN) and terrestrial networks (TN) could either operate in two different frequency bands (for example, frequency range 1 (FR1) vs FR2), or in same frequency band (for example, FR1 or FR2).

In a discontinuous coverage of satellite scenario, UEs are bound to have coverage at only specific times due to the continuous movement of the satellites or satellite constellations.

Before the start of an event that makes the UE unavailable, the UE includes an indication and type of unavailability, the start of the unavailability period if known and the unavailability period duration if known and triggers either mobility registration update or UE initiated de-registration procedure to indicate to network the unavailability information.

For NR satellite access that provides discontinuous network coverage, and in case both UE and network indicate support for “unavailability period support,” the following applies:

If the UE determines lose coverage and decides to remain in no service during coverage lose period, then:
a UE out-of-coverage period may be determined, which expressed by a start of unavailability period and/or unavailability period duration indicating the timing information for when a UE is expected to be out of coverage, and when the UE is expected to re-gain coverage again. The UE out-of-coverage period may consider current and expected future locations of the UE.

The UE may determine that the UE is in NR/evolved universal terrestrial radio access network (E-UTRAN) satellite access discontinuous coverage, optionally for a selected PLMN or network, through at-least one of the below methods:
a) Based on the start of the unavailability period and/or unavailability period duration determined by the UE, indicated by the network (i.e., by any network function such as AMF, mobility management entity (MME) etc.) or negotiated between the UE and the network. For example—if the current time is after the start time and the unavailability period duration is not over, the UE may determine that the UE is in discontinuous coverage, optionally for the selected PLMN or network;
b) Based on the unavailability type, which indicates that the unavailability period is due to NR/E-UTRAN satellite access network discontinuous coverage;
c) Based on any of the network broadcast parameters or messages or any network indication (such as SIB-19, SIB-32);
d) Based on UE determination;
e) Based on satellite coverage availability information (SCAI) provided to the UE by application function (AF) or the 5GC network function (NF) (e.g., AMF/policy control function (PCF)/unified data management (UDM) or any other NF etc.) or any other entity such as satellite coverage availability function (SCAF); and
f) Based on any other methods or indication.

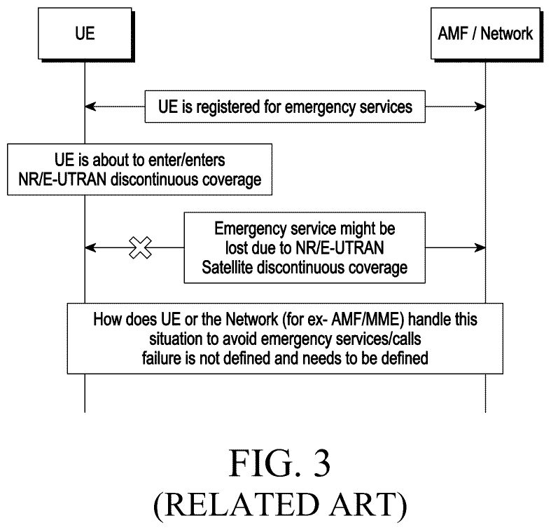

FIG. 3 illustrates a scenario for handling emergency services and NR/E-UTRAN satellite access network. The UE may be registered to/for emergency services (for example, registered for emergency services or emergency registered or emergency registration is successful) or the UE may be registering to emergency services (i.e., emergency registration is ongoing) or the emergency services are ongoing over NR/E-UTRAN satellite access network. The UE may be about to enter NR/E-UTRAN Satellite discontinuous coverage or enters NR/E-UTRAN satellite discontinuous coverage. Currently, it is not defined if how the emergency services/emergency registration may be handled when the UE is about to enter/the UE enters the NR/E-UTRAN Satellite discontinuous coverage. The emergency services may be lost or the UE may disable its access stratum for satellite access or the UE may disable its access stratum for all the services and the UE may not be able to get emergency services. Also, when the UE is in NR/E-UTRAN satellite discontinuous coverage, it is not defined whether the UE may be able to access emergency services or not.

Consider a scenario, wherein there is negotiation/indication of “start of unavailability period” and “unavailability period duration” between the UE and the network. The UE and the network may include/negotiate the support for unavailability period, the start of the unavailability period (if known) and the unavailability period duration (if known) during any of the AS/NAS signalling message or procedure (For ex-registration procedure). Before the start of an event that makes the UE unavailable, the UE includes an indication and type of unavailability, the start of the unavailability period (if known) and the unavailability period duration (if known) and triggers mobility registration update.

The network (for example, AMF/MME) indicates to the UE in a registration accept whether the UE is not required to perform a registration procedure when the unavailability period has ended, is delayed or is cancelled. If there is a change in the network configuration, update in the network deployment or due to any other reasons, if the network (for example, AMF or the MME) determines a change in any of the “unavailability period support” or the “start of the unavailability period” or the “unavailability period duration,” the network may wait for the next registration procedure from the UE to indicate/include/negotiate the change in any of the “unavailability period support” or the “start of the unavailability period” or the “unavailability period duration” to the UE.

Currently, there is no method for the network to include/indicate the change in the configuration of any of these parameters to the UE (for example, at 10 am, The UE and the network negotiated that the start of unavailability period as 12 μm, and unavailability period duration as 2 hrs. At 11 am, the network determines that the start of the unavailability period is now changed to 11.30 am and the unavailability period duration as 1.5 hrs. There is no way for the network to indicate the change in the start of unavailability period or the change in unavailability period duration to the UE. The network (for example, AMF or MME) may have indicated to the UE during the registration procedure not to perform a registration procedure when the unavailability period has ended, is delayed or is cancelled. However, if the UE determines that there is a change in any of the “unavailability period support” or the “start of the unavailability period” or the “unavailability period duration” before/during/after the discontinuous coverage/unavailability period due to any reasons (i.e., due to change in UE location, change in UE configuration etc.).

Currently, there is no way for the UE to indicate the changes in any of these parameters to the network (for example, at 10 am, the UE and the network negotiated that the start of unavailability period as 12 pm and unavailability period duration as 2 hrs. At 1 pm, when the UE is in discontinuous coverage, if the UE determines that the unavailability period duration as 1.5 hours and discontinuous period may end at 1.30 pm. However, there is no way for the UE to indicate the change in the unavailability period duration to the network, optionally when the discontinuous coverage period/unavailability period is over and the network has previously indicated to the UE not to perform a registration procedure when the unavailability period has ended, is delayed or is cancelled.

Hence, there is a need in the art for solutions which may overcome the above mentioned drawback(s), among others.

The principal object of the embodiments herein is to disclose methods and systems for handling a graceful release of a mobile base station relay (MBSR) user equipment (UE).

Another object of the embodiments herein is to disclose the behavior of connected UEs and MBSR UE, when an MBSR UE is not allowed to act as MBSR.

Another object of the embodiments herein is to disclose actions to be taken by a network/access and mobility management function (AMF) before de-registering an MBSR UE.

Another object of the embodiments herein is to disclose actions to be taken by the UE's connected via the MBSR UE to prevent service loss.

Another object of the embodiments herein is to disclose methods and systems for handling emergency calls, start of unavailability period, and unavailability period duration for discontinuous coverage scenarios in wireless communication networks.

Another object of the embodiments herein is to disclose methods and systems for handling emergency services for the UE when the UE is about to enter and enters in or comes out of a new radio (NR)/evolved universal terrestrial radio access network (E-UTRAN) satellite discontinuous coverage.

Another object of the embodiments herein is to disclose methods and systems for negotiating/indicating/including any changes in any of an “unavailability period support” or the “start of the unavailability period” or the “unavailability period duration” when the UE is about to enter, enters in or comes out of the NR/E-UTRAN satellite discontinuous coverage.

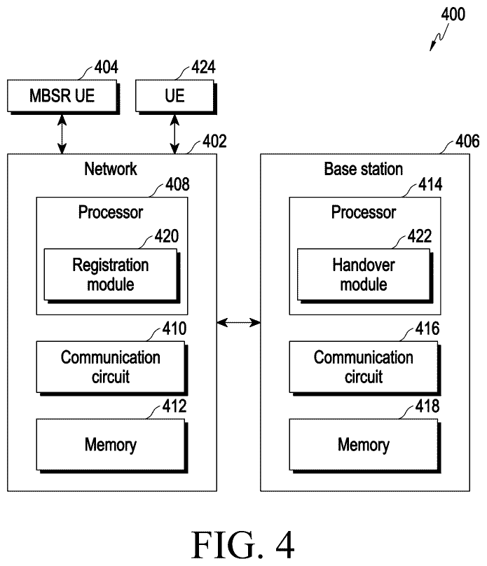

The embodiments herein achieve a methods and systems for handling a graceful release of a mobile base station relay (MBSR) user equipment (UE), and handling emergency calls, start of unavailability period, and unavailability period duration for discontinuous coverage scenarios in wireless communication networks. Referring now to the drawings, and more particularly to FIGS. 4 through 11, where similar reference characters denote corresponding features consistently throughout the figures, there are shown embodiments.

FIG. 4 depicts a system 400 for handling an MBSR UE 404. The system 400 comprises a network 402, at least one MBSR UE 404, a base station 406, and at least one UE 424. The network 402 is an AMF. The network 402 further comprises a processor 408, a communication circuit 410, and a memory 412. The MBSR UE 404 is configured for using one or more services e.g., emergency services.

In an embodiment herein, the processor 408 of the network 402 is configured to perform a de-registration procedure with the MBSR UE 404, based on an authorization/subscription status of the MBSR UE 404 that is registered with the network 402. The processor 408 further comprises a registration module 420.

In an embodiment herein, the registration module 420 can verify status of at least one of a subscription, and an authorization of at least one MBSR UE 404, when the MBSR UE 404 is registered with the network 402. The registration module 420 can trigger an indication to the base station 406, if the status of the subscription of the MBSR UE 404 has expired, or the authorization of the MBSR UE 404 has changed to unauthorized, when the MBSR UE 404 is registered with the network 402. The indication to the base station 406 is an authorization indication indicating the MBSR UE 404 as non-authorized.

In an embodiment herein, the registration module 420 can receive an indication, from the base station 406, indicating the operation for a non-authorized MBSR has completed, if the base station 406 performs a non-authorization of MBSR of the MBSR UE 404 based on the status of at least one of the subscription, and the authorization of the MBSR UE 404.

In an embodiment herein, the registration module 420 can perform a de-registration procedure with the MBSR UE 404, on receiving the indication from the base station 406.

In an embodiment herein, the registration module 420 can handle emergency services for at least one UE 424 during discontinuous coverage. When a UE 424 is registered to/for emergency services or the UE 424 may be registering to emergency services or the emergency services are ongoing over new radio (NR)/evolved universal terrestrial radio access network (E-UTRAN) satellite access network, the registration module 420 can handover the UE 424 or trigger/perform a handover procedure for the UE 424 to any other available network/public land mobile network (PLMN)/radio access technology (RAT), optionally to continue the emergency services or to get normal services. In an embodiment herein, the registration module 420 can handover the UE 424 or trigger/perform a handover procedure for the UE 424 to any other available network/PLMN/RAT, before the UE 424 enters/is about to enter NR/E-UTRAN satellite discontinuous coverage, optionally if emergency call/service is ongoing.

In an embodiment herein, when a UE 424 is registered to/for emergency services or the UE 424 may be registering to emergency services or the emergency services are ongoing over NR/E-UTRAN satellite access network, the UE 424 may not request/indicate/include the support of “unavailability period” or “discontinuous coverage support” or “Unavailability type” or “start of unavailability period” or “unavailability period duration” to the network 402 in any of the access stratum (AS)/non-access-stratum (NAS) signalling message.

In an embodiment herein, when a UE 424 is registered to/for emergency services or the UE 424 may be registering to emergency services or the emergency services are ongoing over NR/E-UTRAN satellite access network, the UE 424 may perform/trigger a PLMN selection, optionally to get emergency/normal services.

In an embodiment herein, the UE 424 may initiate/trigger emergency services or emergency registration when the UE 424 is in NR/E-UTRAN Satellite discontinuous coverage or optionally when the access stratum is disabled in the UE 424 because of the satellite discontinuous coverage.

In an embodiment herein, when the UE 424 is de-registered from the emergency services, the UE 424 may request/indicate/include the support of “unavailability period” to the network 402 in any of the AS/NAS signalling message. In an embodiment herein, when the UE 424 is de-registered from the emergency services, the UE 424 may request/indicate/include any of the “unavailability period support” or “start of unavailability period” or “unavailability period duration” or “discontinuous coverage support” in any of the AS/NAS signalling message.

In an embodiment herein, base station 406 further comprises a processor 414, a communication circuit 416, and a memory 418. The processor 414 further comprises a handover module 422.

In an embodiment herein, the handover module 422 can receive an indication of status of at least one of the subscription of the MBSR UE 404, and the authorization of the MBSR UE 404, from the network 402. The handover module 422 can perform a handover of one or more UEs connected to the MBSR UE 404, to at least one of an alternative base station, and an alternative MBSR UE, based on the indication of status received from the network 402. The handover module 422 can send an indication with a cause code to the network 402, on completing the handover of the UEs. The base station 406 sends the indication indicating the operation for a non-authorized MBSR has completed.

In an embodiment herein, the processor 408, and the processor 414 can process and execute data of a plurality of modules of the network 402, and the base station 406 respectively. The processor 408, and the processor 414 can be configured to execute instructions stored in the memory 412, and the memory 418 respectively. The processor 408, and the processor 414 may comprise one or more of microprocessors, circuits, and other hardware configured for processing. The processor 408, and the processor 414 can be at least one of a single processer, a plurality of processors, multiple homogeneous or heterogeneous cores, multiple central processing units (CPUs) of different kinds, microcontrollers, special media, and other accelerators. The processor 408, and the processor 414 may be an application processor (AP), a graphics-only processing unit (such as a graphics processing unit (GPU), a visual processing unit (VPU)), and/or an artificial intelligence (AI)-dedicated processor (such as a neural processing unit (NPU)).

In an embodiment herein, the plurality of modules of the processor 408, and the processor 414 of the network 402, and the base station 406 can communicate via the communication circuit 410, and the communication circuit 416 respectively. The communication circuit 410, and the communication circuit 416 may be in the form of either a wired network or a wireless communication network module. The wireless communication network may comprise, but not limited to, global positioning system (GPS), global system for mobile communications (GSM), Wi-Fi, Bluetooth low energy, near-field communication (NFC), and so on. The wireless communication may further comprise one or more of Bluetooth, ZigBee, a short-range wireless communication (such as ultra-wideband (UWB)), and a medium-range wireless communication (such as Wi-Fi) or a long-range wireless communication (such as 3G/4G/5G/6G and non-3GPP technologies or WiMAX), according to the usage environment.

In an embodiment herein, the memory 412, and the memory 418 may comprise one or more volatile and non-volatile memory components which are capable of storing data and instructions of the modules of the network 402, and the base station 406 to be executed. Examples of the memory 412, and the memory 418 can be, but not limited to, NAND, embedded multi media card (eMMC), secure digital (SD) cards, universal serial bus (USB), serial advanced technology attachment (SATA), solid-state drive (SSD), and so on. The memory 412, and the memory 418 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory 412, and the memory 418 may, in some examples, be considered a non-transitory storage medium. The term “non-transitory” may indicate that the storage medium is not embodied in a carrier wave or a propagated signal. However, the term “non-transitory” should not be interpreted to mean that the memory 412, and the memory 418 is non-movable. In certain examples, a non-transitory storage medium may store data that can, over time, change (for example, in random access memory (RAM) or cache).

FIG. 4 shows example modules of the network 402, and the base station 406, but it is to be understood that other embodiments are not limited thereon. In other embodiments, the network 402, and the base station 406 may include less or more number of modules. Further, the labels or names of the modules are used only for illustrative purpose and does not limit the scope of the disclosure. One or more modules can be combined together to perform same or substantially similar function in the network 402, and the base station 406 respectively.

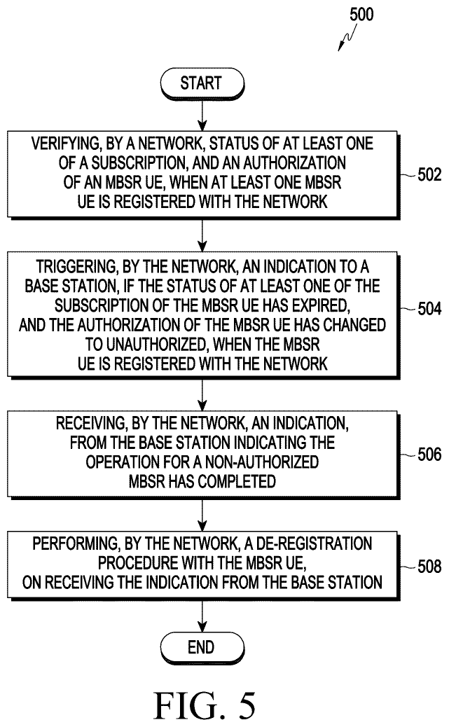

FIG. 5 depicts a method 500 for handling the MBSR UE 404 by the network 402. The method 500 comprises verifying, by the network 402, status of at least one of a subscription, and an authorization of the MBSR UE 404, as depicted in step 502. The network 402 verifies the status when the MBSR UE 404 is registered with the network 402. The method 500 comprises triggering, by the network 402, an indication to the base station 406, if the status of at least one of the subscription of the MBSR UE 404 has expired, and the authorization of the MBSR UE 404 has changed to unauthorized, as depicted in step 504, when the MBSR UE 404 is registered with the network 402.

Thereafter, the method 500 comprises receiving, by the network 402, an indication from the base station 406 indicating the operation for a non-authorized MBSR has completed, as depicted in step 506. The base station 406 performs handover procedure for non-authorizing MBSR. The method 500 comprises performing, by the network 402, a de-registration procedure with the MBSR UE 404, as depicted in step 508, on receiving the indication from the base station 406.

The various actions in method 500 may be performed in the order presented, in a different order or simultaneously. Further, in some embodiments, some actions listed in FIG. 5 may be omitted.

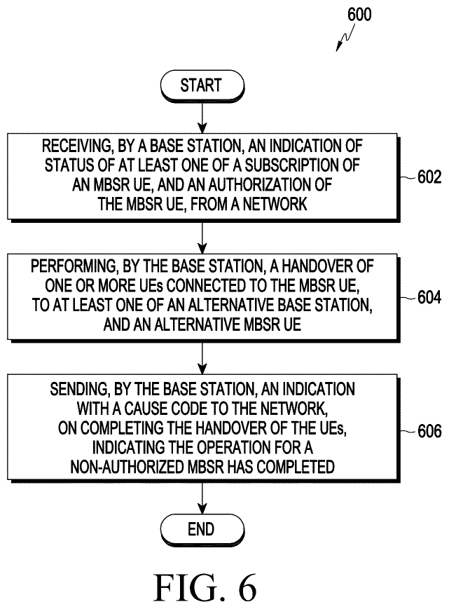

FIG. 6 depicts a method 600 for handling the MBSR UE 404 by the base station 406. The method 600 comprises receiving, by the base station 406, an indication of status of at least one of a subscription of an MBSR UE 404, and an authorization of the MBSR UE 404, as depicted in step 602, from the network 402. The method 600 comprises performing, by the base station 406, a handover of one or more UEs connected to the MBSR UE 404, to at least one of an alternative base station, and an alternative MBSR UE 404, as depicted in step 604, based on the indication of status received from the network 402. Therefore, the method 600 comprises sending, by the base station 406, an indication with a cause code to the network 402, as depicted in step 606, on completing the handover of the UEs. The base station 406 sends the indication indicating the operation for a non-authorized MBSR has completed.

The various actions in method 600 may be performed in the order presented, in a different order or simultaneously. Further, in some embodiments, some actions listed in FIG. 6 may be omitted.

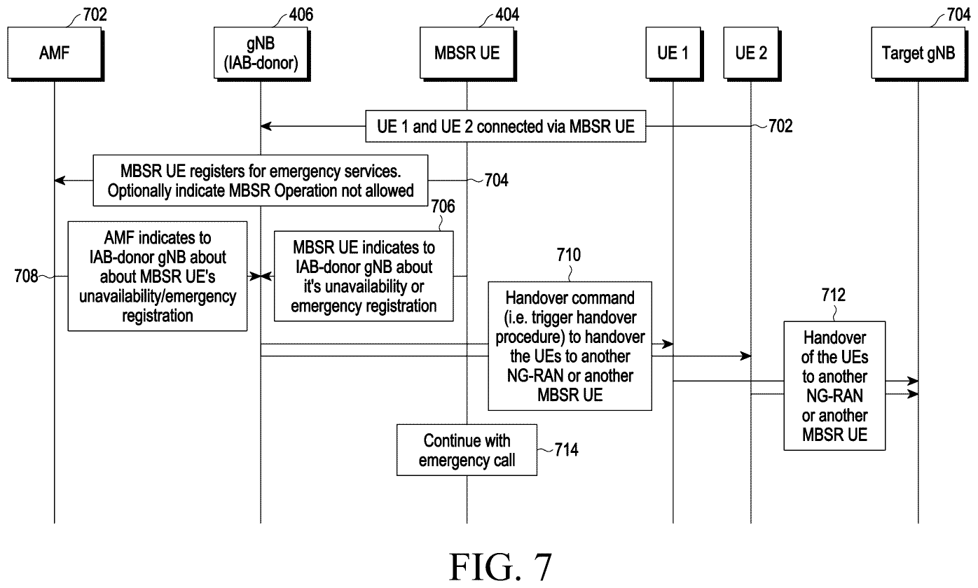

FIG. 7 depicts a scenario where an MBSR UE 404 is not allowed to act as the MBSR UE 404 when the MBSR UE is for e.g., registered for an emergency service. As depicted in step 702, UE 1 and UE 2 are connected to the gNB 406 (integrated access and backhaul (IAB)-donor) via the MBSR UE 404. When the MBSR UE 404 is triggering registration for emergency service, optionally in this case the MBSR UE 404 may indicate as MBSR operation not allowed to the gNB 406 (even though subscription data from a unified data management (UDM) indicates its allowed to operate as MBSR UE 404), or to the AMF 702 as shown in step 704.

In another embodiment, when the MBSR UE 404 registers for emergency services, the UDM may not indicate in an AMF subscription data that MBSR-operation is allowed. When the MBSR UE 404 registers for emergency services, the MBSR UE 404 may indicate emergency registration to the IAB-donor gNB 406 in any message or indication as depicted in step 706. In another embodiment, the AMF 702 can indicate to the IAB-donor gNB 406 that the MBSR UE 404 has registered for emergency services and is unavailable now, as shown in step 708.

Once the IAB-donor gNB 406 receives an indication/message/signal from the AMF 702 or the MBSR UE 404 about MBSR UE's emergency registration, the IAB-donor gNB 406 triggers handover procedure for the UEs connected to the MBSR UE 404 as shown in step 710; i.e., the IAB-donor gNB 406 handovers the UEs connected to MBSR UE 404 to another available gNB or another MBSR UE 404 i.e., target next generation radio access network (NG-RAN) or gNB 704.

In another embodiment, the MBSR UE 404 itself triggers handover of connected UEs to the target NG-RAN or gNB 704, as depicted in step 712. In yet another embodiment, when the MBSR UE 404 is registering for an emergency service, the MBSR UE 404 may not indicate that the MBSR UE 404 intends to behave as MBSR to network 402 (either to IAB-donor central unit (CU) or NG-RAN or AMF) in any access stratum (AS) or non-access stratum (NAS) signalling message. The network 402 also may not indicate to the MBSR UE 404 that the network 402 can act as MBSR (i.e., the network 402 supports MBSR). The MBSR UE 404 may continue with emergency call as shown in step 714.

In yet another embodiment, the MBSR UE 404, even when registered for emergency service, can continue to act as MBSR.

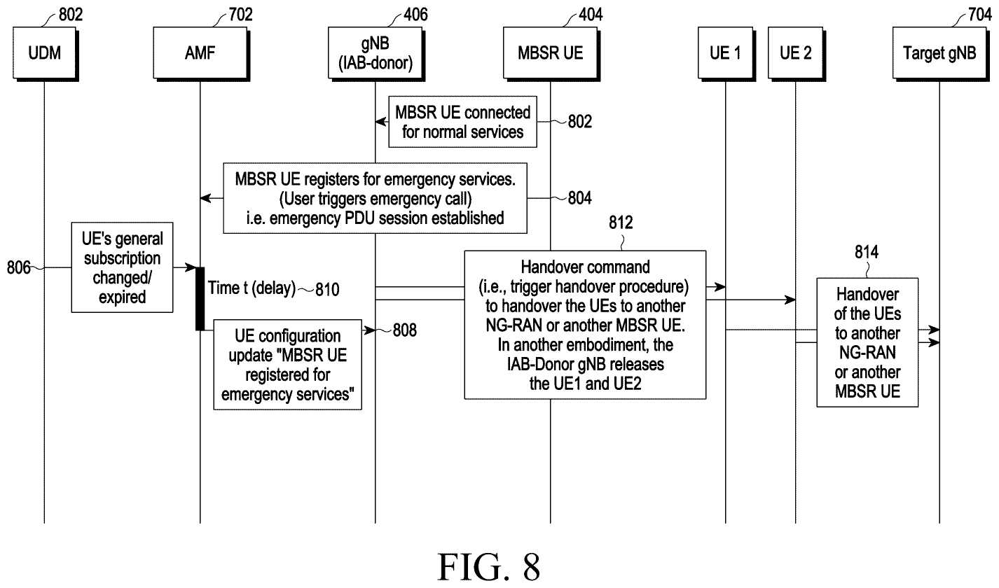

FIG. 8 depicts another scenario where an MBSR UE 404 is not allowed to act as the MBSR UE 404 when registered for an emergency service. The MBSR UE 404 is registered for normal services. Also, MBSR authorization of the MBSR UE 404 is authorized, as shown in step 802. Consider that the MBSR UE 404 is having an active emergency packet data unit (PDU) session, for example, the MBSR UE 404 is having an emergency call, or the user triggers an emergency call and the MBSR UE 404 establishes an emergency PDU session as shown in step 804.

The MBSR UE's subscription has expired during the emergency call or the MBSR authorization of the MBSR UE 404 has changed to not authorized example during the emergency call, as depicted in step 806. The network 402 or AMF 702 cannot trigger de-registration procedure at this time as the MBSR UE 404 has an active emergency PDU session, but rather the network 402 or AMF 702 may trigger a UE configuration update (UCU) procedure with “MBSR UE registered for emergency services” as depicted in step 808. Optionally, the UCU procedure may be triggered, after a delay (the AMF 702 uses a timer t as shown in step 810 (it can be any timer), when the timer t expires, the AMF 702 triggers the UCU procedure), so that the MBSR UE 404 or the IAB-gNB is able to complete the procedure of handover of all connected UEs as shown in steps 812 and 814, so that there is no impact to connected UEs i.e., Graceful release of all connected UEs can take place.

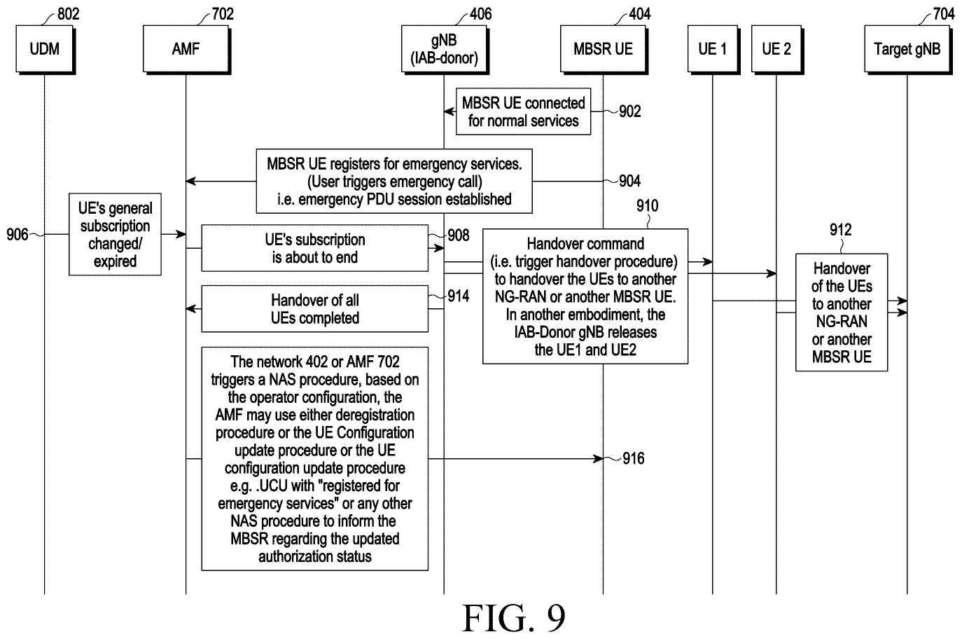

FIG. 9 depicts another scenario where an MBSR UE 404 is not allowed to act as the MBSR UE 404 when registered to a network 402 for example due to emergency service. Consider that the MBSR UE 404 is registered for normal services. Also, MBSR authorization of the MBSR UE 404 is authorized as shown in step 902. The MBSR UE 404 optionally is having an active emergency PDU session; for example, the MBSR UE 404 is having an emergency call, or the user triggers an emergency call and the MBSR UE 404 establishes an emergency PDU session, as shown in step 904. This step 904 is optional in this flow.

Consider that the UEs subscription has expired or the MBSR authorization of the MBSR UE 404 has changed to not authorized, as depicted in step 906. The network 402 or AMF 702 triggers an indication to the IAB-Donor gNB 406 about the MBSR UE's subscription getting expired or is about to expire or authorization is unauthorized (if subscription is expired then it's obvious that MBSR is not authorized too), as depicted in step 908. Once the MBSR UE 404 or the IAB-donor gNB 406 receives an indication that the MBSR UEs subscription is getting expired and it's no more authorized for MBSR operations, the IAB-donor gNB 406 or the MBSR UE 404 initiates handover of all connected UEs to other target gNB 704 or other target MBSR UE, as depicted in steps 910 and 912.

The MBSR UE 404 or IAB-donor gNB 406 sends an indication or acknowledgement to the serving AMF 702 or other network entity that all connected UEs have been handed over to target cell 704 i.e., unauthorized MBSR operations are completed, as depicted in step 914. The network 402 or AMF 702 triggers a NAS procedure, based on the operator configuration, the AMF 702 may use either a deregistration procedure or the UE configuration update procedure e.g., UCU with “registered for emergency services” or any other NAS procedure to inform the MBSR regarding the updated authorization status, as depicted in step 916, after receiving an indication or acknowledgement from the MBSR UE 404 or the IAB-donor gNB 406, to IAB-donor gNB 406 so that there is no impact to connected UEs MBSR; i.e., graceful release of all connected UE can take place.

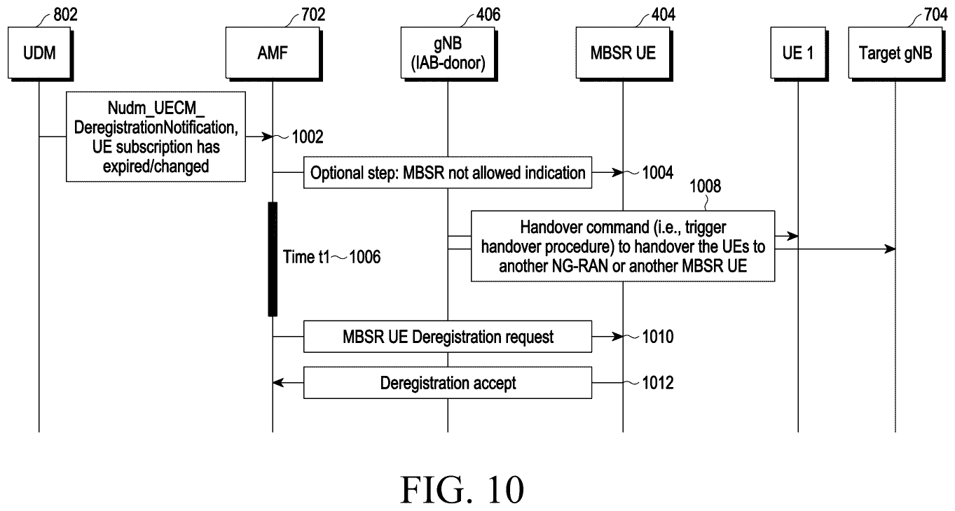

FIG. 10 depicts a scenario depicting one or more actions performed by the network/AMF 702 before de-registering an MBSR UE 404 and the actions performed by the UEs connected via MBSR UE 404 to prevent service loss. When the MBSR UE 404 general subscription has changed and the UDM 802 sends a Nudm_UECM_DeregistrationNotification to the AMF 702 as shown in step 1002, and the network/AMF 702 decides to trigger a network initiated de-registration procedure for the MBSR UE 404, even though the MBSR UE 404 is allowed to act as MBSR, the network/AMF 702 may:
Indicate to the MBSR UE 404 that the MBSR UE 404 may not act as MBSR as shown in step 1004. To do this, the AMF 702 of the MBSR can indicate to the MBSR UE 404 that it is not allowed to act as an MBSR, i.e., the MBSR authorization indication (not authorized), as part of registration/de-registration/UCU or any other NAS/AS procedure. When the MBSR authorization state changes for a registered MBSR node (either authorized, or not authorized), the AMF 702 updates the MBSR and the NG-RAN accordingly. Based on the operator configuration, the AMF 702 may use either a de-registration (including the option with re-registration required indication) or the UE configuration update procedure or any other NAS procedure to inform the MBSR UE 404 regarding the updated authorization status. However, the step of indicating to the MBSR UE 404 that the MBSR UE 404 may not act as MBSR can be optional; and
The AMF 702 may then initiate the de-registration procedure for the MBSR UE 404 with existing reject causes for e.g., #11 etc., as described in TS 24.501.

In another embodiment, the network/AMF 702 indicates to the MBSR UE 404 that its subscription has changed, in any message/indication to the MBSR UE 404, and waits for a time of timer t1 (can be any timer) as shown in step 1006, before triggering the de-registration procedure for the MBSR UE 404. The MBSR UE 404 or the IAB-donor gNB 406 can then initiate handover of connected UEs to another/target gNB 704 before the timer t1 expires as shown in step 1008.

Once the MBSR UE 404 handovers the connected UEs, the network/AMF 702 may then, after some delay, i.e., on expiry of timer t1 trigger the network initiated de-registration procedure to de-register the MBSR UE 404 as shown in step 1010. The AMF 702/network must try to delay the de-registration of the MBSR UE 404 as much as possible. The AMF 702/network may avoid to de-register the MBSR UE 404 with cause re-registration required. Later, the MBSR UE 404 sends a de-registration accept message to the AMF 702, as depicted in step 1012, on de-registering from the network/AMF 702.

For example, if the authorization state changes from authorized to not authorized, and the AMF 702 uses the de-registration procedure to update the MBSR, the AMF 702 sends a UE context modification message to NG-RAN with the authorization indication as not authorized. If the AMF 702 receives a next-generation application protocol (NGAP) UE context release request message from the NG-RAN with a cause code indicating the NG-RAN node has completed, then the operation for a non-authorized MBSR, including e.g., the handover of the UEs the MBSR was serving, or after a certain period, (for example, based on the expiration of a timer configured on the AMF) the AMF 702 executes the de-registration procedure with MBSR, and releases the NAS signalling connection.

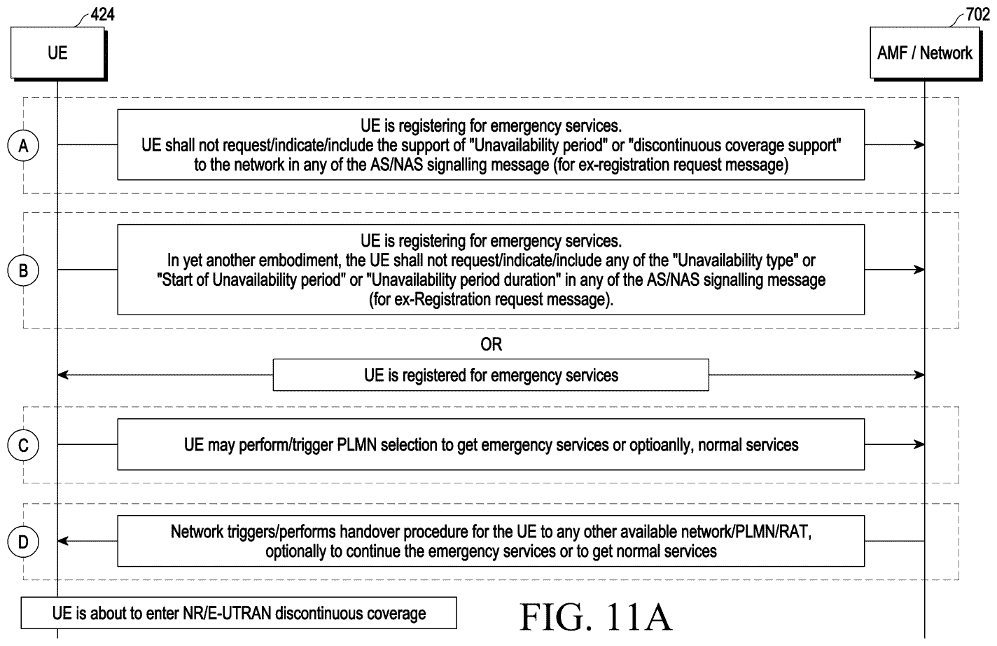

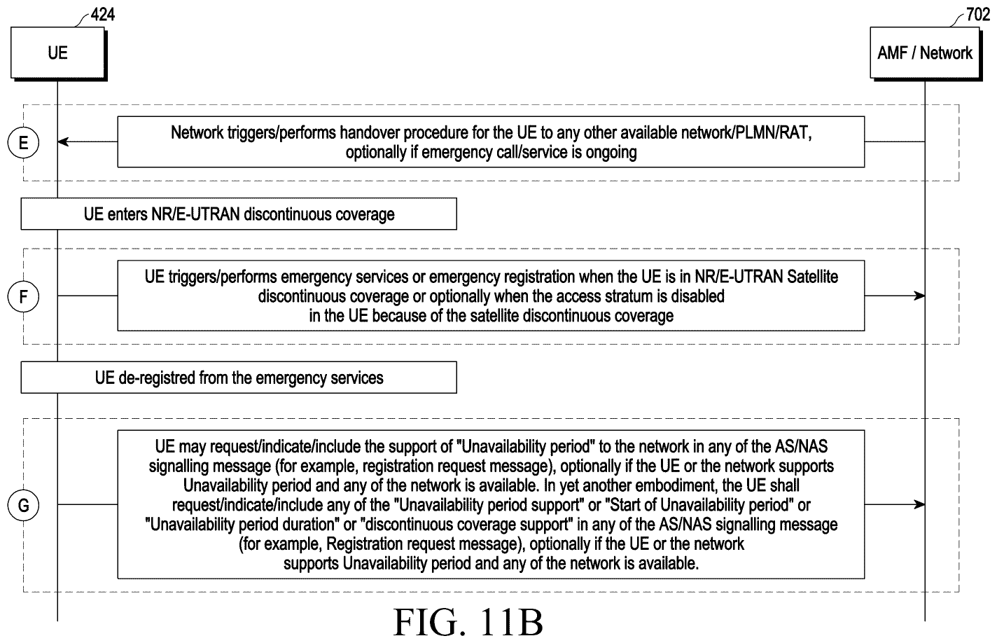

FIG. 11 depicts a method for handling emergency services for a UE 424 when the UE 424 is about to enter, enters, or is in, or comes out of new radio (NR)/evolved universal terrestrial radio access network (E-UTRAN) satellite discontinuous coverage. When the UE 424 is registered to/for emergency services (for example, registered for emergency services or emergency registered or emergency registration is successful) or the UE 424 may be registering to emergency services (i.e., emergency registration is ongoing) or the emergency services are ongoing over NR/E-UTRAN satellite access network, the UE 424 and/or the network/AMF 702 may perform at-least one of the below steps in any order or combination, optionally before/during/after the discontinuous coverage and/or the emergency services:
A) The UE 424 may not request/indicate/include the support of “unavailability period” or “discontinuous coverage support” to the network 402 in any of the AS/NAS signalling message (for example, registration request message);
B) In yet another embodiment, the UE 424 may not request/indicate/include any of the “Unavailability type” or “start of unavailability period” or “unavailability period duration” in any of the AS/NAS signalling messages (for example, registration request message).
C) The UE 424 may perform/trigger PLMN selection without registered PLMN (RPLMN) or PLMN selection with RPLMN, optionally to get emergency/normal services.
D) The network or network function (for example, AMF or MME) may handover the UE or trigger/perform Handover procedure for the UE to any other available network/PLMN/RAT, optionally to continue the emergency services or to get normal services;
E) The network or network function (for example, AMF or MME) may handover the UE 424 or trigger/perform handover procedure for the UE 424 to any other available network/PLMN/RAT, before the UE 424 enters/is about to enter NR/E-UTRAN satellite discontinuous coverage, optionally if emergency call/service is ongoing;
F) The UE 424 is allowed to initiate/trigger emergency services or emergency registration when the UE 424 is in NR/E-UTRAN satellite discontinuous coverage or optionally when the access stratum is disabled in the UE 424 because of the satellite discontinuous coverage; and
G) After the NR/E-UTRAN Satellite discontinuous coverage is over or the UE 424 is no more in the NR/E-UTRAN Satellite discontinuous coverage (for example, due to change in the registration area or the TAI) or the emergency services are over or the UE 424 is no more registered for emergency services or the UE 424 is de-registered from the emergency services, the UE 424 may request/indicate/include the support of “unavailability period” to the network in any of the AS/NAS signalling message (for example, registration request message), optionally if the UE 424 or the network supports Unavailability period and any of the network is available. In yet another embodiment, the UE 424 may request/indicate/include any of the “unavailability period support” or “start of unavailability period” or “unavailability period duration” or “discontinuous coverage support” in any of the AS/NAS signalling message (for example, registration request message), optionally if the UE 424 or the network 402 supports Unavailability period and any of the network 402 is available.

Embodiments herein disclose methods 500, 600 and systems 400 for negotiating/indicating/including any changes in any of the “unavailability period support” or the “start of the unavailability period” or the “unavailability period duration” when the UE 424 is about to enter, enters or is in NR/E-UTRAN satellite discontinuous coverage.

The UE 424 and the network 402 may include/negotiate the support for unavailability period, the start of the unavailability period (if known) and the unavailability period duration (if known) during any of the AS/NAS signalling message or procedure (For example, registration procedure). Before the start of an event that makes the UE 424 unavailable, the UE 424 includes an indication and type of unavailability, the start of the unavailability period (if known) and the unavailability period duration (if known) and triggers a mobility registration Update. The network 402 (for example, AMF/MME) indicates to the UE 424 in the registration accept whether the UE 424 is not required to perform a registration procedure when the unavailability period has ended, is delayed or is cancelled.

If there is a change in the network configuration, update in the network deployment or due to any other reasons, if the network 402 (for example, AMF or the MME) determines a change in any of the “unavailability period support” or the “start of the unavailability period” or the “unavailability period duration,” then the network 402 may initiate a UE configuration update (UCU) command or UE parameters update (UPU) command or any of the AS/NAS signalling message to indicate and/or to include the change in the “unavailability period support” and/or the “start of the unavailability period” and/or the “unavailability period duration.” The network 402 may include new values of the “unavailability period support” and/or the “start of the unavailability period” and/or the “unavailability period duration,” or the network 402 may include/indicate the change in the values of any of these parameters as an offset value from the previously negotiated value (for example if the value is delayed by 1 hr (i.e., +1 hr can be included as an offset, for the respective changed parameter), or if the value is preponed by 1 hr (i.e., −1 hr can be included as an offset, for the respective changed parameter)).

In yet another embodiment, the network 402 may include only the values which are changed (i.e., if start of unavailability period is changed), only start of unavailability period (for example, new value or as an offset) is included by the network 402 to the UE 424 in any of the AS/NAS signalling messages (for example, in UE Configuration Update command) and other values may be skipped/not included. In yet another embodiment, the network 402 may include all the values (both changed values, for the parameters/IE which is changed as well the unchanged value, for the parameters/IE which is unchanged) (for example, if start of unavailability period is changed, start of unavailability period is included (for example, new value or as an offset) and the Unavailability period duration is also included (for example, old/previously negotiated values) by the network 402 to the UE 424) in any of the AS/NAS signalling messages. The UE 424 may determine and store/update the changes in the values of the included/indicated parameters (for example the start of the unavailability period and/or the unavailability period duration) indicated by the network 402 in any of the AS/NAS signalling message (for example, in UE CONFIGURATION UPDATE command).

If some of the parameters are not indicated by the network 402 in the AS/NAS signalling message, then the UE 424 may optionally keep/store the old values of the parameters which are not included. In yet another embodiment, if some of the parameters are not indicated by the network 402 in the AS/NAS signalling message, then the UE 424 may optionally delete the old/stored values of the parameters which are not included. For example, at 10 am, the UE 424 and the network 402 negotiated that the start of unavailability period as 12 pm and unavailability period duration as 2 hrs. At 11 am, the network 402 determines that the start of the unavailability period is now changed to 11.30 am and the unavailability period duration as 1.5 hrs.

The network 402 may trigger any AS/NAS signalling message (for example, a UE configuration update command) towards the UE 424, either when the network 402 determines the change (i.e., at 11 am) or just before the new updated value (i.e., before 11.30 am) or just before the UE 424 is about to enter the discontinuous coverage, optionally as determined by the network 402 or indicated by the UE 424 or negotiated between the UE 424 and the network 402 or optionally at the new determined “start of Unavailability period” by the UE 424 or the network 402, but with sufficient time for the UE 424 and the network 402 to complete the AS/NAS signalling procedure or to complete any other ongoing services/ongoing priority services/ongoing emergency calls or anytime between when the network 402 determines the change/new updated time/parameters (i.e., at 11 am), and the changed/actual time i.e., the new start of unavailability period, optionally if changed and/or determined (i.e., at/before 11.30 am), and include/indicate the change in the values of the changed parameters (i.e., include/indicate the start of unavailability period as 11.30 am and include/indicate the unavailability period duration as 1.5 hours.

How the UE 424 treats the AMF 702 provided unavailability period duration is up to UE implementation, for example, to help to determine when to return to coverage after a discontinuous coverage period, whether to listen to paging in extended discontinuous reception (eDRX), not to initiate any NAS signalling (including service request for mobile-originated (MO) data) within the discontinuous coverage period in case of any uplink (UL) signalling/data request or the UE 424 may deactivate its access stratum functions for NR satellite access in order to optimize power consumption until coverage returns, etc.

The network 402 (For example, AMF or MME) might have indicated to the UE 424 during the registration procedure not to perform a registration procedure when the unavailability period has ended, is delayed or is cancelled. If the UE 424 determines that there is a change in any of the “unavailability period support” or the “start of the unavailability period” or the “unavailability period duration” during/after the discontinuous coverage/unavailability period, due to any reasons (i.e., due to change in UE location, change in UE configuration, change in UE trajectory etc., or due to any reasons), then the UE 424 may trigger a registration procedure (for example mobility registration update procedure) or any AS/NAS signalling procedure, optionally if or when the network 402 is available or if/when the UE 424 is registered or if/when any service is available for the UE 424, to indicate/include the change in the “unavailability period support” and/or the “start of the unavailability period” and/or the “unavailability period duration.”

The network 402 (for example, AMF or MME) may indicate to the UE 424 during the registration procedure not to perform a registration procedure when the unavailability period has ended, but the UE 424 may indicate to the network 402 if there is any change in unavailability period duration/start timer/cancel of the event/event is delayed to a future time. The UE 424 may trigger a NAS procedure like registration procedure when there is any change in unavailability period duration/start time/cancel of the event/event is delayed to a future time, optionally, after discontinuous coverage started (i.e., UE enters DC period).

The UE 424 may trigger a NAS procedure like registration procedure when there is any change in unavailability period duration/start time/cancel of the event/event is delayed to a future time, optionally, after discontinuous coverage started (i.e., UE enters DC period).

The UE 424 may include new values of the “unavailability period support” and/or the “start of the unavailability period” and/or the “unavailability period duration” or the UE 424 may include/indicate the change in the values of any of these parameters as an offset value from the previously negotiated value (for example, if the value is delayed by 1 hr (i.e., +1 hr can be included as an offset, for the respective changed parameter) or if the value is preponed by 1 hr (i.e., −1 hr can be included as an offset, for the respective changed parameter)).

In yet another embodiment, the UE 424 may include only the values which are changed (i.e., if start of unavailability period is changed, only start of unavailability period (for example, new value or as an offset) is included by the UE 424 to the network 402) in any of the AS/NAS signalling messages (for example, in registration procedure) and other values may be skipped/not included. In yet another embodiment, the UE 424 may include all the values (both changed values, for the parameters/IE which is changed as well the unchanged value, for the parameters/IE which is unchanged) (for example, if start of unavailability period is changed, start of unavailability period is included (for example, new value or as an offset) and the Unavailability period duration is also included (for example, old/previously negotiated values) by the UE 424 to the network 402) in any of the AS/NAS signalling messages.

The network 402 may determine and store/update the changes in the values of the indicated/included parameters (for example, the start of the unavailability period and/or the unavailability period duration indicated by the UE 424) in any of the AS/NAS signalling message (for example, in registration procedure). If some of the parameters are not indicated by the network 402 in the AS/NAS signalling message, then the network 402 may optionally keep/store the old values of the parameters which are not included. In yet another embodiment, if some of the parameters are not indicated by the UE 424 in the AS/NAS signalling message, then the network 402 may optionally delete the old/stored values of the parameters which are not included.

Accordingly, the embodiments herein provide a method for handling a mobile base station relay (MBSR) user equipment (UE) by a network. The method comprises verifying status of at least one of a subscription, and an authorization status of the MBSR UE, when at least one MBSR UE is registered with the network. The method comprises triggering an indication to a base station (i.e., NG-RAN node), if the status of at least one of the subscription/authorization of the MBSR UE has expired, and the authorization of the MBSR UE has changed to unauthorized, when the MBSR UE is registered with the network. The method comprises receiving an indication, from the base station, indicating the operation for a non-authorized MBSR has completed. Thereafter, the method comprises performing a de-registration procedure with the MBSR UE, on receiving the indication from the base station.

In an embodiment, the method comprises: receiving, by the base station, the indication of status of the at least one of the subscription of the MBSR UE, and the authorization of the MBSR UE, from the network; performing, by the base station, a handover of one or more UEs which are connected to the MBSR UE, to at least one of an alternative base station, and an alternative MBSR UE; and sending, by the base station, the indication with a cause code to the network, on completing the handover of the one or more UEs, wherein the base station sends the indication indicating the operation for the non-authorized MBSR has completed.

In an embodiment, the network is an Access and Mobility Management Function (AMF).

In an embodiment, the base station is a Next Generation-Radio Access Network (NG-RAN) node.

In an embodiment, the indication to the base station is an authorization indication indicating the MBSR UE as non-authorized.

In an embodiment, wherein the MBSR UE is configured for using one or more emergency services.

Accordingly, the embodiments herein provide a network which comprises a processor, and a memory. The processor is coupled with the memory. The processor is configured to verify status of at least one of a subscription, and an authorization of an MBSR UE, when at least one MBSR UE is registered with the network. The processor is configured to trigger an indication to a base station, if the status of at least one of the subscription of the MBSR UE has expired, and the authorization of the MBSR UE has changed to unauthorized, when the MBSR UE is registered with the network. The processor is configured to receive an indication, from the base station, indicating the operation for a non-authorized MBSR has completed. Further, the processor is configured to perform a de-registration procedure with the MBSR UE, on receiving the indication from the base station.

In an embodiment, the base station is configured to: receive the indication of status of the at least one of the subscription of the MBSR UE, and the authorization of the MBSR UE, from the network; perform a handover of one or more UEs which are connected to the MBSR UE, to at least one of an alternative base station, and an alternative MBSR UE, based on the indication of status received from the network; and send the indication with a cause code to the network, on completing the handover of the one or more UEs, wherein the base station sends the indication indicating the operation for the non-authorized MBSR has completed.

In an embodiment, the network is an Access and Mobility Management Function (AMF).

In an embodiment, the base station is a Next Generation-Radio Access Network (NG-RAN) node.

In an embodiment, the indication to the base station is an authorization indication indicating the MBSR UE as non-authorized.

In an embodiment, the MBSR UE is configured for using one or more emergency services.

Accordingly, the embodiments herein provide a method for handling an MBSR UE by a base station. The method comprises receiving an indication of status of at least one of a subscription of an MBSR UE, and an authorization of the MBSR UE, from a network. The method comprises performing a handover of one or more UEs connected to the MBSR UE, to at least one of an alternative base station, and an alternative MBSR UE, based on the indication of status received from the network. The method comprises sending an indication with a cause code to the network, on completing the handover of the UEs, wherein the base station sends the indication indicating the operation for a non-authorized MBSR has completed.

Accordingly, the embodiments herein provide a base station which comprises a processor, and a memory. The processor is coupled with the memory. The processor is configured to receive an indication of status of at least one of a subscription of an MBSR UE, and an authorization of the MBSR UE, from the network. The processor is configured to perform a handover of one or more UEs connected to the MBSR UE, to at least one of an alternative base station, and an alternative MBSR UE, based on the indication of status received from the network. Further, the processor is configured to send an indication with a cause code to the network, on completing the handover of the UEs, wherein the base station sends the indication indicating the operation for a non-authorized MBSR has completed.

The embodiments disclosed herein can be implemented through at least one software program running on at least one hardware device and performing network management functions to control the network elements. The elements include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a network entity for handling a mobile base station relay (MBSR), the method comprising:
identifying that an MBSR authorization state changes to not authorized;
transmitting, to a base station, a first message including an authorization indication indicating that the MBSR authorization state is not authorized;
receiving, from the base station, a second message including a first indication indicating that an operation for a non-authorized MBSR has completed; and
performing a de-registration procedure with the MBSR in response to receiving the first indication.

2. The method of claim 1, wherein the operation for the non-authorized MBSR has completed includes a handover operation of at least one UE related to the MBSR.

3. The method of claim 1, wherein the network entity is an access and mobility management function (AMF) entity.

4. The method of claim 1, wherein the first message includes a user equipment (UE) context modification message, and
wherein the second message includes a next-generation application protocol (NGAP) UE context release request message.

5. The method of claim 1, wherein the MBSR is configured for using one or more emergency services.

6. A network entity for handling a mobile base station relay (MBSR), the network entity comprising:
a transceiver; and
at least one processor coupled to the transceiver and configured to:
identify that an MBSR authorization state changes to not authorized,
transmit, to a base station, a first message including an authorization indication indicating that the MBSR authorization state is not authorized,
receive, from the base station, a second message including a first indication indicating that an operation for a non-authorized MBSR has completed, and
perform de-registration procedure with the MBSR in response to receiving the first indication.

7. The network entity of claim 6, wherein the operation for the non-authorized MBSR has completed includes a handover operation of at least one UE related to the MBSR.

8. The network entity of claim 6, wherein the network entity is an access and mobility management function (AMF) entity.

9. The network entity of claim 6, wherein the first message includes a user equipment (UE) context modification message, and
wherein the second message includes a next-generation application protocol (NGAP) UE context release request message.

10. The network entity of claim 6, wherein the MBSR is configured for using one or more emergency services.

11. A method of a base station for handling a mobile base station relay (MBSR), the method comprising:
receiving, from a network entity, a first message including an authorization indication that an MBSR authorization state changes to not authorized;
performing an operation for a non-authorized MBSR based on the authorization indication; and
transmitting, to the network entity, a second message including a first indication indicating that the operation for the non-authorized MBSR has completed.

12. The method of claim 11, wherein the operation for the non-authorized MBSR has completed includes a handover operation of at least one UE related to the MBSR.

13. The method of claim 11, wherein the network entity is an access and mobility management function (AMF) entity.

14. The method of claim 11, wherein the first message includes a user equipment (UE) context modification message, and
wherein the second message includes a next-generation application protocol (NGAP) UE context release request message.

15. The method of claim 11, wherein the MBSR is configured for using one or more emergency services.

16. A base station for handling a mobile base station relay (MBSR), the base station comprising:
a transceiver; and
at least one processor coupled to the transceiver and configured to:
receive, from a network entity, a first message including an authorization indication that an MBSR authorization state changes to not authorized,
perform an operation for a non-authorized MBSR based on the authorization indication, and
transmit, to the network entity, a second message including a first indication indicating that the operation for the non-authorized MBSR has completed.

17. The base station of claim 16, wherein the operation for the non-authorized MBSR has completed includes a handover operation of at least one UE related to the MBSR.

18. The base station of claim 16, wherein the network entity is an access and mobility management function (AMF) entity.

19. The base station of claim 16, wherein the first message includes a user equipment (UE) context modification message, and
wherein the second message includes a next-generation application protocol (NGAP) UE context release request message.

20. The base station of claim 16, wherein the MBSR is configured for using one or more emergency services.
